(19) United States
(12) Patent Application Publication
(10) Pub. No.: US 2004/0200403 A1
(43) Pub. Date: Oct. 14, 2004

(54) Interactive warning indicator reminder device, the original terror alert level indicating device

(76) Inventors: Michael Francis O'Shaughnessy, Newcastle (IE); Frances O'Shaughnessy, Newcastle (IE)

Correspondence Address: MICHAEL F. O'SHAUGHNESSY, ATHANOR, KILTYMON, NEWCASTLE, CO. WICKLOW, IE

(21) Appl. No.: 10/827,743

(22) Filed: Apr. 13, 2004

(30) Foreign Application Priority Data
Apr. 11, 2003 (IE) S2003/0278

(51) Int. Cl. G01D 13/00

(52) U.S. Cl. 116/200

(57) ABSTRACT

A device may provide a user with means to display an indication of the status of a government issued Terror Alert Level Warning and may be manufactured in a variety of forms and sizes to facilitate use in a range of environments. The method of display may be by any of various means such as a color code or an audio signal or other indicative means. A user may adjust a device manually or otherwise in order to indicate a desired Terror Alert Level Warning status reminder. A device may be manufactured and operated at any preferred level of technological performance. Embodiment may be in 3 dimensions as an object, or appliance, or on a screen in 2 dimensions as a virtual object.

### CROSS-REFERENCE TO RELATED APPLICATIONS

We request and claim the benefit of a prior application to the Irish Patent Office on Apr. 11, 2003, Application Number S2003/0278.

### STATEMENT REGARDING FED. SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

This invention discloses a novel user-interactive display device, which may be adjusted by a user, to produce a required output display, to denote a Terror Alert Status.

This may be achieved by providing a user with a device which may display a color coded scale, or other set of indicative elements, and which may be adjusted to highlight a selected alert level color, or other indicative element.

The state of technology employed in and by the device, and in its manufacture and operation, may be very low tech through to very high tech.

### BRIEF SUMMARY OF THE INVENTION

The object of the invention is to provide a user with the means of maintaining an individual or personal reminder and indicator of a current status of Terror Alert Level as issued by a government.

### BRIEF DESCRIPTION OF THE SEVERAL VIEWS OF THE DRAWING

Not Applicable

### DETAILED DESCRIPTION OF THE INVENTION

Embodiment of a low tech device may be simply fashioned as required in two parts, from any suitable preferred material such as plastic, metal, wood etc. Adjustment of the display may be of a rudimentary nature, achieved by moving one part, manually, to an alternate indicative element on the other part, where it will remain contiguous, adhered or affixed, indicating and reminding a user of the terror alert level status, until it is again moved, manually.

As an example of such embodiment it may be considered that a device may be manufactured from approximately 25 milliliters of HDPE, by molding the material into form as a cylindrical object, having approximate dimensions of 75 mm in length and 15 mm in diameter. The length of such a cylinder may be divided into 5 segments, or bands, of color, with each appropriate color respectively representing the 5 levels of alert.

A marker element, such as a ring around it, may be moved along the length of the cylinder and caused to stop at any preferred color segment, thereby denoting a selected alert warning status. Alternate marker elements such as a pin, a screw or a bolt may be used, by inserting or threading them into an appropriate socket provided in each segment.

Another example of a HDPE molded device may be considered in the form of a disk, of 35 mm in diameter and 3 mm in thickness, having a rotating and appropriately colored internal element which may be aligned to exhibit a required color segment through an aperture or window in the external casing to denote an alert level status.

While 5 colors are known to represent 5 states of alert, a greater, or lesser, number of colors may be used in a device. For example, a preferred embodiment may use 6 colors, the additional color being used to denote the absence of any terror alert status. This is so that a device may also indicate an ‘All Clear’ status.

Example of a preferred embodiment of a device using 6 colors may be considered. It may be made of HDPE, with similar dimensions to the cylindrically shaped embodiment mentioned above. However, each of 6 colored segments may have a corresponding, color-matched, removable marker element. The marker element corresponding to the ‘All Clear’ status, having a slightly greater prominence than the other 5 may be used to denote an alert status, by placing it into the color segment corresponding to the required alert status.

The removed marker element may then be placed into the ‘All Clear’ color segment, which color segment may also be more distinctive than the other 5. This distinction may be achieved by siting the ‘All Clear’ color segment socket on the base of the cylinder, while the other 5 sockets may be sited, as described above, along the length of the device.

Another example of a device may be considered as a kit, or as a set of individual color segments, each of which may be threaded on one side and with a complementary socket on the opposite side, thereby allowing an assembly to be formed, by a user, producing a cylindrically shaped device, with similar dimensions to the cylindrically shaped devices described above.

Such kit, preferably using a 6 alert level arrangement, as described above, may be comprised of 9 components. These may be 6 indicator color segments with two appropriate end-closure segments and an internal separator segment, the latter three may be of a neutral, non-indicating color. Status may be denoted by isolating the required color segment between the separator segment and an end-closure segment, and placing the ‘All Clear’ color segment in the vacant position of the indicating color segment, keeping the remaining color segments in their normal relative positions.

Such kit or set of individual components may also allow a user to assemble or select a device using only a single required color, which may be replaced by any of the other 5, as circumstance may require.

The form and shape of the components of a kit or set of individual color elements may also be various, as also, the material or fabric of which the set may be manufactured.

HDPE is an example only of a material that may be used in the economic manufacture of a device. Any other preferred materials may be appropriately used.

Further embodiment of a device may use electrical, electronic or other means to highlight or display the selected set of indicative elements of the device. The indicating action or function of the indicative elements may be achieved using illumination or other visually perceived stimulus or signal, or sound, or touch, such as Braille or other surface texture, or heat et cetera.

Further embodiment of a device may be constructed as an icon or image on a display such as CRT, LCD, Plasma or other screens, or platforms.

Some examples of application and scale or size of embodiments of a device include personal jewelry, such as ear, neck, wrist, or other ornaments, keyring attachments, brooches, badges, pins et cetera. Versions may be hand-held, placed on table tops, or floor-standing, indoors or outdoors, as may be used in domestic, school, office, factory, sport arena, shopping mall, airport or other enclosed or unenclosed public places.

From such examples, it will be appreciated that a device may be produced in a very wide range of forms and sizes ranging from some millimeters through to some tens of meters in length or height. Other dimensions of a device may be equally variable.

The information communicated by a device may be tactile, visual or audible or any combination of those.

The information input to a device to effect a desired display may be by manual, mechanical, electrical, electronic, chemical or other means.

The output display adjustment of a device may be effected by manual, mechanical, electrical, electronic or other means.

The scale and form of a device may be adapted to suit any point of display, in a 2 dimensional or 3 dimensional manner, to achieve a desired visibility of a device at a point of display.

A device may be manufactured as a free standing, self contained assembly, object or apparatus, or it may be incorporated into a multitude of commonly used items.

A device may be adhered to or suspended from a suitable support or placed on a suitable surface, in a suitable environment.

Regarding visual displays, such as television transmission, telephone services provision, computer services provision, including internet services, and other signal providers, the provider or agent may use a device when the primary function of providing the news of the status, or change of status, of the terror alert level is completed.

For example, a television channel providing news and, or, entertainment, may display a device, continuously or intermittently, as a visual element or icon in the same manner that a corporate identity logo device, a scorekeeping device, or a time clock may be displayed.

Many and various electronic, and other, means exist to enable delivery of a device, including disc, tape and other recording media.

For example, a computer operator may download a device as an interactive software package, from disc etc., or internet or other source, and display it on screen. The operator may then interact to adjust the device display output, by means of the keyboard or other control accessory. The operator may also adjust the display output of a device auto-interactively, by connection or reconnection to a source code or reference signal from an appropriate transmission provider.

Further embodiment of a device may be interfaced with any medium including the internet, radio, television, telephone or other signal generating or transmitting source, to acquire information, which may be displayed interactively by a user.

A device may be incorporated into many consumer products. For example, a television or other display instrument may be manufactured with particular, or other, controls to enable a user to view a device on screen, at any chosen time, irrespective of whether the set is in use or other mode, such as recording or standby. Such an incorporated device may also be auto-interactively set to a terror alert level, by using a normally transmitted signal or other stimulus or other means.

A device, with its multiplicity of form, size, method etc, may be easily distinguished, by virtue of its user interactivity, from any other tool or agent that simply defines or transmits primary news or information of a terror alert level or status.

1. What we claim as our invention is: a novel user-interactive display device, which may provide a means of maintaining an individual or personal reminder and indicator of a current status of terror alert level as issued by a government, and which may display a color coded scale or other set of indicative elements, and which may be adjusted to highlight a selected alert level color or other indicative element.
